(19) United States
(12) Patent Application Publication
(10) Pub. No.: US 2021/0129541 A1
(43) Pub. Date: May 6, 2021

(54) INK ABSORPTION MEMBER AND INK ABSORBER

(71) Applicant: SEIKO EPSON CORPORATION, Tokyo (JP)

(72) Inventor: Yoichi MIYASAKA, Suwa-shi (JP)

(73) Assignee: Seiko Epson Corporation, Tokyo (JP)

(21) Appl. No.: 17/041,488

(22) PCT Filed: Dec. 27, 2018
(86) PCT No.: PCT/JP2018/048016

§ 371 Date: Sep. 25, 2020

(30) Foreign Application Priority Data
Mar. 27, 2018 (JP) 2018-059707

(51) Int. Cl. B41J 2/17; D21H 11/14; D21H 11/16; D21H 19/20; D21H 21/22

(52) U.S. Cl. CPC B41J 2/17; D21H 11/14; D21H 21/22; D21H 19/20; D21H 11/16

(57) ABSTRACT

An ink absorption member is to be used to absorb ink. The ink absorption member includes a fiberized material and a liquid-absorbent resin. The fiberized material includes a fiber. In the ink absorption member, a content of the liquid-absorbent resin is greater than 5 wt. % and 90 wt. % or less relative to a weight of the fiber. Furthermore, it is preferable that a bulk density of the ink absorption member of the present invention be 0.01 g/cm³ or greater and 0.3 g/cm³ or less.

### CROSS-REFERENCE TO RELATED APPLICATIONS

This application is a U.S. National stage application of International Patent Application No. PCT/JP2018/048016, filed on Dec. 27, 2018, which claims priority to Japanese Patent Application No. 2018-059707, filed in Japan on Mar. 27, 2018. The entire disclosure of Japanese Patent Application No. 2018-059707 is hereby incorporated herein by reference.

### TECHNICAL FIELD

The present invention relates to an ink absorption member and an ink absorber.

### BACKGROUND ART

In ink jet printers, waste ink is typically generated during a head cleaning operation, which is performed to prevent a reduction in printing quality due to clogging caused by ink, and during an ink filling operation after a replacement of an ink cartridge. Accordingly, ink jet printers are provided with a liquid absorption member (ink absorption member) for absorbing waste ink, to prevent the occurrence of unintentional adhesion of such waste ink to a mechanism or the like within the printers.

In the related art, as liquid absorption members (ink absorption members), those that include a natural cellulose fiber and/or a synthetic fiber together with a thermally fusible substance have been used (see Japanese Patent No. 3536870, for example).

### SUMMARY

Unfortunately, the liquid absorption members (ink absorption members) of the related art have a low ink penetration property and, therefore, present a problem in that a sufficient amount of waste ink cannot be absorbed, or waste ink cannot be absorbed rapidly. In addition, after ink has been absorbed, unintentional ink leakage may occur in some cases, depending on the amount of the ink absorbed.

An object of the present invention is to provide an ink absorption member and an ink absorber that have an improved ink absorption characteristic and prevent ink leakage from occurring after ink has been absorbed.

The present invention has been made to solve at least some of the problems described above and can be realized in the aspects described below.

An ink absorption member of the present invention is an ink absorption member to be used to absorb ink. The ink absorption member includes a fiberized material and a liquid-absorbent resin. The fiberized material includes a fiber. In the ink absorption member, a content of the liquid-absorbent resin is greater than 5 wt. % and 90 wt. % or less relative to a weight of the fiber.

The inclusion of a fiber and a liquid-absorbent resin in the ink absorption member enables ink dropped onto the ink absorption member to be transmitted along the fiber to be diffused over a relatively wide area in the ink absorption member. While the ink is diffused, the ink is absorbed by the liquid-absorbent resin. Hence, ink can be rapidly diffused, absorbed, and held, and, therefore, an excellent liquid absorption characteristic is achieved.

Furthermore, the content of the liquid-absorbent resin of greater than 5 wt. % and 90 wt. % or less relative to the weight of the fiber enables ink to be favorably diffused, absorbed, and held.

Note that if the content of the liquid-absorbent resin is too low, ink may not be sufficiently held, and, for example, if the container storing the ink absorption member falls over, ink may leak out. On the other hand, if the content of the liquid-absorbent resin is too high, the amount of the fiber is relatively reduced, and, consequently, ink may not be sufficiently diffused.

In the ink absorption member of the present invention, it is preferable that a bulk density of the ink absorption member be 0.01 g/cm³ or greater and 0.5 g/cm³ or less.

In this case, even when an amount (ratio) of ink to be absorbed is relatively large with respect to an amount of the ink absorption member, the ink absorption member can suitably absorb ink, and the ink absorption member is prevented from swelling and expanding out from the container when the ink absorption member absorbs ink.

In the ink absorption member of the present invention, it is preferable that the fiber be a cellulose fiber.

Cellulose is a material having a suitable hydrophilicity, and thus, when ink is applied to the ink absorption member, the ink can be suitably diffused. Hence, the ink absorption member can rapidly escape from a state in which the flowability is particularly high (e.g., a state in which a viscosity is not greater than 10 mPa·s), and, in addition, the ink can be suitably delivered to the liquid-absorbent resin. As a result, an ink absorption characteristic of the ink absorption member as a whole is particularly enhanced. Furthermore, in general, cellulose has a high affinity for liquid-absorbent resins, and, therefore, the liquid-absorbent resin can be more suitably supported on a surface of the fiber. Furthermore, cellulose fibers are renewable natural materials and are inexpensive and readily available compared with various other fibers. As such, cellulose fibers are advantageous also from the standpoint of reducing the cost of producing the ink absorption member, ensuring stable production, and reducing environmental impact, for example.

In the ink absorption member of the present invention, it is preferable that an average length of the fiber be 0.1 mm or greater and 7 mm or less.

In this case, the liquid-absorbent resin can be supported more suitably, and ink can be held and diffused by the fiber more suitably, and, therefore, the ink absorption characteristic of the ink absorption member as a whole is further enhanced.

In the ink absorption member of the present invention, it is preferable that an average diameter of the fiber be 0.5 μm or greater and 200 μm or less.

In this case, the liquid-absorbent resin can be supported more suitably, and ink can be diffused by the fiber more suitably, and, therefore, the ink absorption characteristic of the ink absorption member as a whole is further enhanced.

In the ink absorption member of the present invention, it is preferable that the liquid-absorbent resin be supported on the fiber.

In this case, leakage of the liquid-absorbent resin from the container storing the ink absorption member is more suitably prevented, and the position of the liquid-absorbent resin in the ink absorption member can be fixed to some extent, which prevents unintentional uneven distribution of the liquid-absorbent resin.

In the ink absorption member of the present invention, it is preferable that a raw material for the fiber be previously used waste paper.

In this case, advantages from the standpoint of waste reduction, effective utilization of resources, and the like are achieved.

In the ink absorption member of the present invention, it is preferable that the liquid-absorbent resin be in the form of particles.

In this case, the ink absorption member can be suitably loaded in a container while an ink penetration property is easily ensured. Furthermore, good conformability to containers of various shapes is achieved, which suitably prevents the formation of an unnecessarily large space in the container. Furthermore, in a case in which the ink absorption member includes a fiber such as those described in detail later, the liquid-absorbent resin can be suitably supported on a surface of the fiber.

It is preferable that the ink absorption member of the present invention further include a binder.

In this case, the liquid-absorbent resin can be supported on the fiber more reliably, and the individual fibers can be partially settled together.

An ink absorber of the present invention includes the ink absorption member of the present invention and a container storing the ink absorption member.

In this case, ink can be absorbed while the advantages of the ink absorption member described above are enjoyed.

### BRIEF DESCRIPTION OF DRAWINGS

FIG. 1 is a cross-sectional view of an ink absorption member of the present invention stored in a container.

FIG. 2 is an enlarged view (schematic diagram) of the ink absorption member illustrated in FIG. 1.

FIG. 3 is a schematic diagram (cross-sectional view) illustrating a production apparatus for producing the ink absorption member illustrated in FIG. 1.

### DESCRIPTION OF EMBODIMENTS

An ink absorption member of the present invention will now be described in detail with reference to the accompanying drawings, which illustrate a preferred embodiment.

### EMBODIMENT

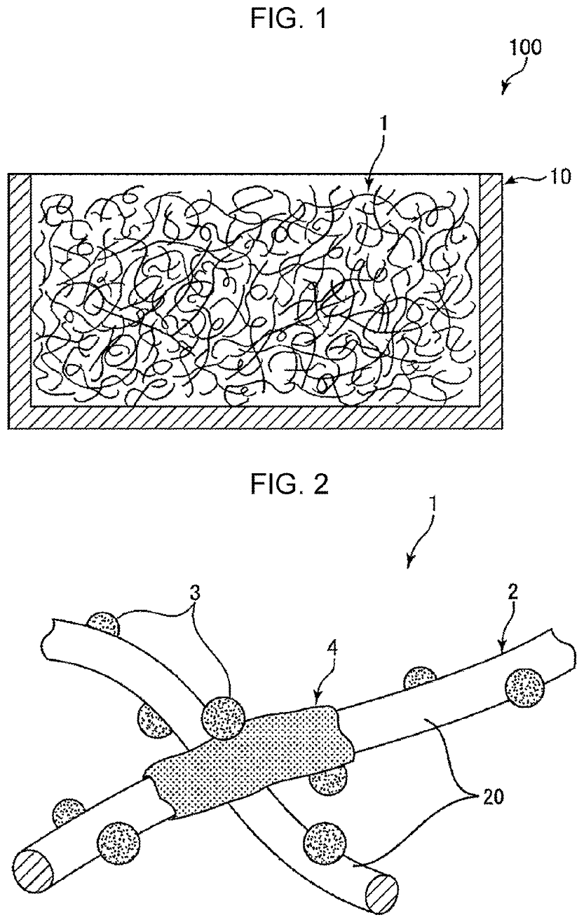

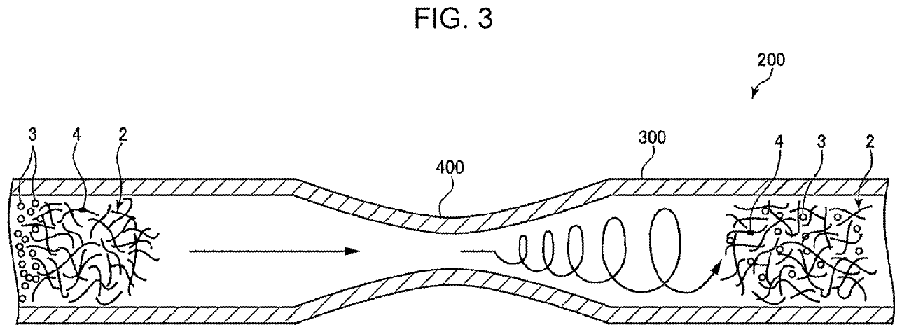

FIG. 1 is a cross-sectional view of an ink absorption member of the present invention stored in a container. FIG. 2 is an enlarged view (schematic diagram) of the ink absorption member illustrated in FIG. 1. FIG. 3 is a schematic diagram (cross-sectional view) of a production apparatus for producing the ink absorption member illustrated in FIG. 1.

Note that hereinafter, upper positions as viewed in FIG. 1 may be referred to as “upper” or “upward” positions, lower positions as “lower” or “downward” positions, left positions as “left” or “upstream” positions, and right positions as “right” or “downstream” positions, for convenience of description.

An ink absorption member 1 of the present invention, illustrated in FIG. 1 and FIG. 2, is an ink absorption member used to absorb ink. The ink absorption member 1 includes a fiberized material 2, which includes fibers 20, and a liquid-absorbent resin 3, with a content of the liquid-absorbent resin 3 being greater than 5 wt. % and 90 wt. % or less relative to a weight of the fibers 20. Furthermore, the content of the liquid-absorbent resin 3 is preferably 20% or greater and 70% or less and more preferably 40% or greater and 55% or less, relative to the fibers 20.

Furthermore, the ink absorption member 1 of the present invention does not have a particular external shape, and, therefore, the ink absorption member 1 has excellent shape conformability and can be stored in a container in conformity with any container shape.

The inclusion of the fibers 20 and the liquid-absorbent resin 3 in the ink absorption member 1 enables an ink Q dropped onto the ink absorption member 1 to be transmitted along the fibers 20 to be diffused over a relatively wide area in the ink absorption member 1. While the ink Q is diffused, the ink Q is absorbed by the liquid-absorbent resin 3. Hence, the ink Q can be rapidly diffused, absorbed, and held, and, therefore, an excellent liquid absorption characteristic is achieved.

Note that if the content of the liquid-absorbent resin 3 is too low, the ink Q may not be sufficiently held, and, for example, if the container storing the ink absorption member 1 falls over, the ink Q may leak out. On the other hand, if the content of the liquid-absorbent resin 3 is too high, the amount of the fibers 20 is relatively reduced, and, consequently, the ink Q may not be sufficiently diffused.

Furthermore, when the content of the liquid-absorbent resin 3 is 20% or greater and 70% or less or 40% or greater and 55% or less, relative to the fibers 20, ink can be diffused, absorbed, and held more favorably.

Furthermore, the ink absorber 100 of the present invention, illustrated in FIG. 1, includes the ink absorption member 1 of the present invention and a container 10, which stores the ink absorption member 1. With the present invention, as described, ink can be absorbed while the advantages of the ink absorption member described above are enjoyed.

Note that as used in this specification, the term “liquid-absorbent” refers to an absorbency for general types of inks. That is, aqueous inks in which a colorant is dissolved in an aqueous solvent can be absorbed, of course, and, in addition, solvent-based inks in which a binder is dissolved in a solvent, UV curable inks in which a binder is dissolved in a liquid monomer and which are cured by UV irradiation, latex inks in which a binder is dispersed in a dispersion medium, and the like can be absorbed.

The container 10 will be described below before the constituent materials of the ink absorption member 1 of the present invention are described.

The container 10, illustrated in FIG. 1, stores the ink absorption member 1. The container 10 is formed of a housing that has an opening portion and a storage space that is in communication with the opening portion. Furthermore, a shape of the housing is not particularly limited provided that the shape is a tubular shape having a closed end, for example. Examples thereof include circular tubular shapes and polygonal tubular shapes. Furthermore, a cover member that closes the opening portion may be included. In this case, the cover member may be formed integrally with the housing or may be included as a separate member.

A constituent material of the container 10 is not particularly limited provided that the material is not an ink-permeable material. Examples of the constituent material include various hard resin materials, various ceramic materials, and various metal materials.

When the container 10 has hardness, unintentional application of an external force to the ink absorption member 1 stored in the container 10 is prevented. Hence, ink leakage due to unintentional application of an external force to the ink absorption member 1 when the ink absorption member 1 absorbs ink is prevented.

Note that the container 10 is not limited to the housing described above and may be in the form of a soft bag. In this case, examples of the constituent material of the container 10 include various soft resin materials and various rubber materials.

When the container 10 is in the form of a soft bag, the ink absorption member 1 can be freely deformed or moved within the container 10 by, for instance, crumpling the ink absorption member 1 together with the container 10, in a state in which the ink absorption member 1 is stored in the container 10.

A capacity of the container 10 is not particularly limited and is approximately 10 cm³ or greater and 20000 cm³ or less.

The container 10, as described, may or may not have optical transparency (internal visibility).

Constituent materials of the ink absorption member 1 of the present invention will now be described.

### <Liquid-Absorbent Resin>

The liquid-absorbent resin 3, illustrated in FIG. 2, is not particularly limited provided that the resin has liquid absorbency. Examples of the liquid-absorbent resin 3 include carboxymethyl cellulose, polyacrylic acids, polyacrylamides, starch-acrylic acid graft copolymers, hydrolysates of starch-acrylonitrile graft copolymers, vinyl acetate-acrylic ester copolymers, isobutylene-maleic acid copolymers, hydrolysates of acrylonitrile copolymers or acrylamide copolymers, polyethylene oxide, polysulfonic acid compounds, polyglutamic acids, salts (neutralized products) thereof, and crosslinked products thereof. As used herein, the term “liquid absorbency” refers to the ability to exhibit hydrophilicity and retain liquid. Many liquid-absorbent resins 3 form a gel when the resins absorb liquid.

In particular, it is preferable that the liquid-absorbent resin 3 be a resin having a functional group in a side chain thereof. Examples of the functional group include acid groups, hydroxyl groups, epoxy groups, and amino groups.

In particular, preferably, the liquid-absorbent resin 3 is a resin having an acid group in a side chain thereof, and, more preferably, the liquid-absorbent resin 3 is a resin having a carboxyl group in a side chain thereof.

Examples of a carboxyl-group-containing unit that may be included in the liquid-absorbent resin 3 include units derived from a monomer such as acrylic acid, methacrylic acid, itaconic acid, maleic acid, crotonic acid, fumaric acid, sorbic acid, cinnamic acid, an anhydride of any of these, or a salt of any of these.

In a case in which the liquid-absorbent resin 3 includes a liquid-absorbent resin 3 that contains an acid group in a side chain thereof, a percentage of acid groups that are neutralized and form a salt of all the acid groups present in the liquid-absorbent resin 3 is preferably 30 mol % or greater and 100 mol % or less, more preferably 50 mol % or greater and 95 molds or less, even more preferably 60 mol % or greater and 90 mol % or less, and most preferably 70 mol % or greater and 80 mol % or less.

In these cases, the liquid-absorbent resin 3 has a further enhanced ink absorption property.

The type of the neutralized salt is not particularly limited, and examples thereof include alkali metal salts, such as sodium salts, potassium salts, and lithium salts, and salts of a nitrogen-containing basic compound, such as ammonia. A sodium salt is preferable.

In these cases, the liquid-absorbent resin 3 has a further enhanced ink absorption property.

The liquid-absorbent resin 3 that contains an acid group in a side chain thereof is preferable because during the absorption of ink, electrostatic repulsion occurs therein between acid groups, which increases the absorption rate. Furthermore, in the case in which acid groups are neutralized, ink can be easily absorbed into the liquid-absorbent resin 3 under osmotic pressure.

The liquid-absorbent resin 3 may include a structural unit that contains no acid group. Examples of such a structural unit include hydrophilic structural units, hydrophobic structural units, and structural units that serve as a polymerizable crosslinking agent.

Examples of the hydrophilic structural units include structural units derived from a nonionic compound, such as acrylamide, methacrylamide, N-ethyl (meth)acrylamide, N-n-propyl (meth)acrylamide, N-isopropyl (meth)acrylamide, N,N-dimethyl (meth)acrylamide, 2-hydroxyethyl (meth)acrylate, 2-hydroxypropyl (meth)acrylate, methoxypolyethylene glycol (meth)acrylate, polyethylene glycol mono(meth)acrylate, N-vinylpyrrolidone, N-acryloylpiperidine, or N-acryloylpyrrolidine.

Examples of the hydrophobic structural units include structural units derived from a compound such as (meth)acrylonitrile, styrene, vinyl chloride, butadiene, isobutene, ethylene, propylene, stearyl (meth)acrylate, or lauryl (meth)acrylate.

Examples of the structural units that serve as a polymerizable crosslinking agent include structural units derived from, for instance, diethyleneglycol diacrylate, N,N′-methylenebisacrylamide, polyethylene glycol diacrylate, polypropylene glycol diacrylate, trimethylolpropane diallyl ether, trimethylolpropane triacrylate, allyl glycidyl ether, pentaerythritol triallyl ether, pentaerythritol diacrylate monostearate, bisphenol diacrylate, isocyanurate diacrylate, tetraallyloxyethane, or a salt of diallyloxyacetic acid.

From the standpoint of absorption performance, cost, and the like, it is preferable that the liquid-absorbent resin 3 be a polyacrylic acid salt copolymer or a crosslinked polyacrylic acid polymer.

In the crosslinked polyacrylic acid polymer, a percentage of carboxyl-group-containing structural units of all the structural units included in the molecular chain is preferably greater than or equal to 50 mol %, more preferably greater than or equal to 80 molds, and even more preferably greater than or equal to 90 mol %.

If the percentage of the carboxyl-group-containing structural units is too low, it may be difficult to ensure a sufficiently good ink absorption performance.

It is preferable that some of the carboxyl groups in the crosslinked polyacrylic acid polymer be neutralized (partially neutralized) and form a salt.

In the crosslinked polyacrylic acid polymer, a percentage of neutralized carboxyl groups of all the carboxyl groups is preferably 30 mol % or greater and 99 mol % or less, more preferably 50 mol % or greater and 99 mol % or less, and even more preferably 70 mol % or greater and 99 mol % or less.

Furthermore, the liquid-absorbent resin 3 may have a structure crosslinked with a crosslinking agent other than the polymerizable crosslinking agent mentioned above.

When the liquid-absorbent resin 3 is a resin containing acid groups, it is preferable that the crosslinking agent be, for example, a compound containing functional groups that are reactive with acid groups.

When the liquid-absorbent resin 3 is a resin containing functional groups that are reactive with acid groups, it is preferable that the crosslinking agent be a compound containing, in the molecule, functional groups that are reactive with acid groups.

Examples of the compound (crosslinking agent) containing functional groups that are reactive with acid groups include glycidyl ether compounds, such as ethylene glycol diglycidyl ether, trimethylolpropane triglycidyl ether, (poly)glycerol polyglycidyl ether, diglycerol polyglycidyl ether, and propylene glycol diglycidyl ether; polyhydric alcohols, such as (poly)glycerol, (poly)ethylene glycol, propylene glycol, 1,3-propanediol, polyoxyethylene glycol, triethylene glycol, tetraethylene glycol, diethanolamine, and triethanolamine; and polyamines and the like, such as ethylenediamine, diethylenediamine, polyethyleneimine, and hexamethylene diamine. Other preferred examples include ions of a multivalent metal, such as zinc, calcium, magnesium, or aluminum. Such ions serve as a crosslinking agent by reacting with acid groups present in the liquid-absorbent resin 3.

In the ink absorption member 1, the liquid-absorbent resin 3 may have any shape and may be in the form of, for example, a block (mass), pellets, flakes, needles, a fiber, particles, or the like. Preferably, the liquid-absorbent resin 3 is in the form of particles. In this case, the ink absorption member 1 can be suitably loaded in the container 10 while an ink penetration property is easily ensured. Furthermore, good conformability to containers 10 of various shapes is achieved, which suitably prevents the formation of an unnecessarily large space in the containers 10. Furthermore, the liquid-absorbent resin 3 can be suitably supported on a surface of the fibers 20.

An average particle diameter of the particles is preferably 15 μm or greater and 800 μm or less, more preferably 15 μm or greater and 400 μm or less, and even more preferably 15 μm or greater and 50 μm or less.

Furthermore, if the average particle diameter of the particles is too large, the liquid-absorbent resin 3 has a reduced specific surface area, which results in a reduced ink absorption characteristic and a reduced ink absorption rate.

Note that the average particle diameter of the particles may be, for example, a mean volume diameter MVD, which is a volume-based mean particle diameter measured with a laser diffraction particle size distribution analyzer. Particle size distribution analyzers using the laser diffraction light scattering method as the measurement principle, that is, laser diffraction particle size distribution analyzers, can measure particle size distributions based on volume.

The particles may include one or more components in addition to the liquid-absorbent resin 3. Examples of such components include surfactants, lubricants, defoamers, fillers, anti-blocking agents, and UV absorbers.

The liquid-absorbent resin 3 (e.g., a liquid-absorbent resin 3 in the form of particles) may have a uniform configuration in its entirety or have different configurations in different locations. For example, in the liquid-absorbent resin 3 (e.g., a liquid-absorbent resin 3 in the form of particles), a region near the surface (e.g., a region extending 1 μm in thickness from the surface) may have a higher degree of crosslinking than other locations.

In this case, an ink absorption factor and absorption rate, a strength of the liquid-absorbent resin 3, and the like are improved in a more balanced manner.

The inclusion of the liquid-absorbent resin 3 described above and the fiberized material 2, which will be described later, enables ink dropped onto the ink absorption member 1 to be transmitted along the fibers 20 to be diffused over a relatively wide area in the ink absorption member; thus, an excellent diffusibility is achieved. While the ink is diffused, the ink is absorbed by the liquid-absorbent resin. Hence, ink can be rapidly diffused, absorbed, and held, and, therefore, an excellent liquid absorption characteristic is achieved.

Furthermore, the content of the liquid-absorbent resin of greater than 5 wt. % and 90 wt. % or less relative to the weight of the fibers 20 enables ink to be favorably diffused, absorbed, and held.

Furthermore, when the content of the liquid-absorbent resin 3 is within the above-mentioned numerical range, even if an amount (ratio) of ink to be absorbed is relatively large with respect to an amount of the ink absorption member 1, the ink absorption member 1 can suitably absorb the ink, and, therefore, effects such as those described above are stably produced over a long period of time while an increase in the size of the apparatus in which the ink absorption member 1 is to be included is effectively prevented. Furthermore, the frequency of replacement of the ink absorption member 1 can be reduced, and as a result, maintenance of the apparatus that includes the ink absorption member 1 is easy.

Note that if the content of the liquid-absorbent resin is too low, ink may not be sufficiently held, and, for example, if the container storing the ink absorption member falls over, ink may leak out.

On the other hand, if the content of the liquid-absorbent resin is too high, the amount of the fibers 20 is relatively reduced, and, consequently, ink may not be sufficiently diffused. Furthermore, a bulk density is relatively reduced, and, consequently, ink may not be sufficiently diffused. In addition, if too large an amount of the liquid-absorbent resin is present, swelling at the portion onto which ink has been dropped becomes excessive, and, consequently, the diffusion of ink may be hindered, and protrusion from the container 10 may occur. To prevent the protrusion, it is conceivable to reduce the amount of the ink absorption member 1 in the container 10. However, in this case, a total ink absorption amount is reduced.

Furthermore, when the content of the liquid-absorbent resin 3 is greater than 5 wt. % and 90 wt. % or less relative to the weight of the fibers 20, the effects of the present invention can be produced; however, the content is preferably 20 wt. % or greater and 70 wt. % or less relative to the weight of the fibers 20 and more preferably 40 wt. % or greater and 55 wt. % or less relative to the weight of the fibers 20. In these cases, effects associated with the absorption rate, diffusibility, leakage prevention, and the like are produced in a balanced manner, and, therefore, the effects of the present invention are produced more prominently.

### <Fiberized Material>

The fiberized material 2, illustrated in FIG. 2, is formed of the fibers 20. The fiberized material 2 has a function of supporting the liquid-absorbent resin 3 and a function of diffusing dropped ink rapidly over a wide area. Accordingly, ink can be delivered to the liquid-absorbent resin 3 more efficiently, and, hence, an ink absorption characteristic of the ink absorption member 1 as a whole is improved. In addition, unintentional ink leakage after the ink absorption member 1 has absorbed ink is prevented.

Furthermore, the liquid-absorbent resin 3 is supported on the fibers 20, that is, the liquid-absorbent resin 3 exists in the ink absorption member 1 in a state in which the liquid-absorbent resin 3 is supported on the fibers 20; as a result, leakage of the liquid-absorbent resin 3 from the container 10 storing the ink absorption member 1 is more suitably prevented, and the position of the liquid-absorbent resin 3 in the ink absorption member 1 can be fixed to some extent, which prevents unintentional uneven distribution of the liquid-absorbent resin 3.

A shape of the fiberized material 2 may be, for instance, a shape in the form of a linear or strip-shaped bundle of the fibers 20 or a shape in the form of a mass in which the fibers 20 are entangled, that is, a shape in which a so-called aggregate is formed.

Since the fiberized material 2 is in such a form, a shape of the ink absorption member 1 can be freely changed in the container 10.

Note that the liquid-absorbent resin 3 may not be supported on the fibers 20, that is, the ink absorption member 1 may be in a state in which the liquid-absorbent resin 3 is simply mixed with the fiberized material 2. That is, a state in which the absorbent resin 3 is diffused and dispersed in the fiberized material 2 is possible. In this case, a step of causing the liquid-absorbent resin 3 to be supported on the fibers 20 can be omitted, and, therefore, the ink absorption member 1 can be easily obtained.

Examples of the fibers 20 include synthetic resin fibers, such as polyester fibers and polyamide fibers; and natural resin fibers, such as cellulose fibers, keratinous fibers, and fibroin fibers, and chemical modifications thereof; these may be used alone or in an appropriate combination. Preferably, the fibers 20 is primarily formed of a cellulose fiber (which may be included, for example, in an amount greater than or equal to 70 wt. %), more preferably, the fibers 20 are substantially entirely formed of a cellulose fiber.

Cellulose is a material having a suitable hydrophilicity, and thus, when ink is applied to the ink absorption member 1, the ink can be suitably diffused. Hence, the ink absorption member 1 can rapidly escape from a state in which the flowability is particularly high (e.g., a state in which a viscosity is not greater than 10 mPa·s), and, in addition, the ink can be suitably delivered to the liquid-absorbent resin 3. As a result, the ink absorption characteristic of the ink absorption member 1 as a whole is particularly enhanced. Furthermore, in general, cellulose has a high affinity for the liquid-absorbent resin 3, and, therefore, the liquid-absorbent resin 3 can be more suitably supported on a surface of the fibers 20. Furthermore, cellulose fibers are renewable natural materials and are inexpensive and readily available compared with various other fibers. As such, cellulose fibers are advantageous also from the standpoint of reducing the cost of producing the ink absorption member 1, ensuring stable production, and reducing environmental impact, for example.

Note that in this specification, it is sufficient that the cellulose fiber be a material containing, as a major component, a compound of cellulose (cellulose in a narrow sense) and being in the form of a fiber, and thus, the material may include hemicellulose and/or lignin in addition to cellulose (cellulose in a narrow sense).

Furthermore, it is preferable that a raw material for the fibers 20 be previously used waste paper. In this case, advantages from the standpoint of waste reduction, effective utilization of resources, and the like are achieved.

Methods for fiberizing waste paper (raw material paper) include, for example, a method that uses a fiberizing apparatus including an impeller mill, which may include a high-speed rotor and a liner located at the outer periphery of the rotor.

In a case in which waste paper is used as a raw material for the fibers 20, the waste paper may be unprocessed waste paper or may be a shredded material obtained from a shredding process or a fiberized material obtained from a fiberization process.

Furthermore, methods for mixing the liquid-absorbent resin 3 with the fiberized material 2 include, for example, a method that uses a mixing apparatus 200, illustrated in FIG. 3.

As illustrated in FIG. 3, the mixing apparatus 200 includes a mixing tube 300 and a gas flow generating source that generates a gas flow in the mixing tube 300. Furthermore, the mixing tube 300 has, at a middle thereof, a diameter-reduced portion 400, in which an inner diameter of the mixing tube 300 is reduced. This configuration generates a swirling flow downstream of the diameter-reduced portion 400.

When the fibers 20, the liquid-absorbent resin 3, and a binder 4 are introduced into the mixing tube 300, a swirling flow occurs downstream of the diameter-reduced portion, which causes the fiberized material 2, the liquid-absorbent resin 3, and the binder 4 to be stirred and mixed together. As a result, the ink absorption member 1 is obtained in a state in which the fiberized material 2, the liquid-absorbent resin 3, and the binder 4 are favorably mixed together.

Note that, for example, supplying moisture into the mixing tube 300 causes the liquid-absorbent resin 3 to be supported on the fibers 20 directly or via the binder 4.

An average length of the fibers 20 is not particularly limited and is preferably 0.1 mm or greater and 7 mm or less, more preferably 0.1 mm or greater and 5 mm or less, and even more preferably 0.1 mm or greater and 3 mm or less. In these cases, the liquid-absorbent resin 3 can be supported more suitably, and ink can be held and delivered to the liquid-absorbent resin 3 by the fibers 20 more suitably, and, therefore, the ink absorption characteristic of the ink absorption member 1 as a whole is further enhanced.

An average diameter (average width) of the fibers 20 is not particularly limited and is preferably 0.5 μm or greater and 200 μm or less and more preferably 1.0 μm or greater and 100 μm or less. In these cases, the liquid-absorbent resin 3 can be supported more suitably, and ink can be held and delivered to the liquid-absorbent resin 3 by the fibers 20 more suitably, and, therefore, the ink absorption characteristic of the ink absorption member 1 as a whole is further enhanced.

An average aspect ratio (the ratio of the average length to the average width) of the fibers 20 is not particularly limited and is preferably 10 or greater and 1000 or less and more preferably 15 or greater and 500 or less.

In these cases, the liquid-absorbent resin 3 can be supported more suitably, and ink can be held and delivered to the liquid-absorbent resin 3 by the fibers 20 more suitably, and, therefore, the ink absorption characteristic of the ink absorption member 1 as a whole is further enhanced.

Furthermore, in the case in which the liquid-absorbent resin 3 is in the form of particles, it is preferable that a relationship of 0.15≤L/D≤467 be satisfied where D is the average particle diameter [μm] of the liquid-absorbent resin 3, and L is the average length [μm] of the fibers 20; more preferably, a relationship of 0.25≤L/D≤333 is satisfied, and even more preferably, a relationship of 2≤L/D≤200 is satisfied.

In these cases, the liquid-absorbent resin 3 can be supported more suitably, and ink can be held and delivered to the liquid-absorbent resin 3 by the fibers 20 more suitably, and, therefore, the ink absorption characteristic of the ink absorption member 1 as a whole is further enhanced.

In the ink absorption member 1 of the present invention, a content of the fibers 20 is preferably 0.5 wt. % or greater and 80 wt. % or less, more preferably 1.0 wt. % or greater and 70 wt. % or less, and even more preferably 3.0 wt. % or greater and 67 wt. % or less.

In these cases, the effects of the inclusion of the fibers 20 are produced more prominently while the effects of the inclusion of the liquid-absorbent resin 3, such as those described above, are sufficiently produced.

### <Binder>

The binder 4, illustrated in FIG. 2, has a function of binding the liquid-absorbent resin 3 to the fibers 20 and a function of binding the individual fibers together. The additional inclusion of the binder 4 enables the liquid-absorbent resin 3 to be supported on the fibers 20 more firmly and a relative positional relationship between the fibers 20 to be maintained to some extent. Hence, unintentional uneven distribution of the liquid-absorbent resin is prevented.

Note that the binder 4 may be added separately in the production of the ink absorption member 1, or the binder 4 may be present in the ink absorption member 1, the principle of which is described below.

In some cases, previously used waste paper includes a resin (a component that can be a binder 4), that is, a binder 4 that has functions such as those described above, derived from the papermaking process. In a case in which such waste paper is used as a raw material to obtain a fiberized material, and the fiberized material is used as the fibers 20, the fibers 20 originally contain a binder 4 adhering thereto or being present therein. In a case in which such a fiberized material 2 and the liquid-absorbent resin 3 are used to produce the ink absorption member 1, the ink absorption member 1 contains a binder 4 being present therein. Thus, the binder 4 may be a binder derived from the waste paper that is used as a raw material for the fiberized material 2.

The binder 4 is not particularly limited provided that the binder 4 exhibits the functions described above. Examples of the binder 4 include thermoplastic resins and curable resins; a thermoplastic resin is preferable. Examples of the thermoplastic resin include AS resins, ABS resins, polyolefins and modified polyolefins such as polyethylene, polypropylene, and ethylene-vinyl acetate copolymers (EVA), acrylic resins such as polymethylmethacrylate, polyvinyl chloride, polystyrene, polyesters such as polyethylene terephthalate and polybutylene terephthalate, polyamides (nylons) such as nylon 6, nylon 46, nylon 66, nylon 610, nylon 612, nylon 11, nylon 12, nylon 6-12, and nylon 6-66, polyphenylene ether, polyacetal, polyethers, polyphenylene oxide, polyetheretherketone, polycarbonate, polyphenylene sulfide, thermoplastic polyimides, polyetherimides, liquid crystal polymers such as aromatic polyesters, water-soluble polymers such as PVA and PAP, and various thermoplastic elastomers such as styrene-based, polyolefin-based, polyvinyl chloride-based, polyurethane-based, polyester-based, polyamide-based, polybutadiene-based, trans-polyisoprene-based, fluorocarbon rubber-based, or chlorinated polyethylene-based thermoplastic elastomers. One or two more selected from these may be used alone or in combination. It is preferable to use a polyester or a polyester-containing resin as the thermoplastic resin.

In the ink absorption member 1, a content of the binder 4 is preferably less than or equal to 10 wt. % and more preferably less than or equal to 5.0 wt. %. In these cases, the liquid-absorbent resin 3 can be supported on the fibers 20 more reliably.

### <Other Components>

The ink absorption member 1 may include one or more components (other components) in addition to the ones described above.

Examples of such components include surfactants, lubricants, defoamers, fillers, anti-blocking agents, UV absorbers, colorants, such as pigments and dyes, flame retardants, and flow improvers.

In the ink absorption member 1, a content of the other components is preferably less than or equal to 10 wt. % and more preferably less than or equal to 5.0 wt. %.

Furthermore, a bulk density of the ink absorption member 1 in the container 10 is preferably 0.01 g/cm³ or greater and 0.5 g/cm³ or less and more preferably 0.03 g/cm³ or greater and 0.3 g/cm³ or less. In these cases, even when the amount (ratio) of ink to be absorbed is relatively large with respect to the amount of the ink absorption member 1, the ink absorption member 1 can suitably absorb ink, and the ink absorption member 1 is prevented from swelling and expanding out from the container 10 when the ink absorption member 1 absorbs ink.

If the bulk density is too high, the liquid-absorbent resin 3 may swell when the liquid-absorbent resin 3 absorbs ink, which may cause the ink absorption member 1 to expand out from the container 10. On the other hand, if the bulk density is too low, there is a tendency for the amount of ink that can be absorbed by the ink absorption member 1 to decrease.

Furthermore, A/B is preferably 0.1 or greater and 0.9 or less and more preferably 0.2 or greater and 0.8 or less where A is a volume of the ink absorption member 1 in the container 10, and B is a capacity (maximum capacity) of the container 10. In these cases, even when the amount (ratio) of ink to be absorbed is relatively large with respect to the amount of the ink absorption member 1, the ink absorption member 1 can suitably absorb ink, and the ink absorption member 1 is prevented from swelling and expanding out from the container 10 when the ink absorption member 1 absorbs ink.

It is sufficient that the ink absorption member 1 of the present invention have a function of absorbing ink. Examples of the ink absorption member 1 include ones used to absorb waste ink generated during a head cleaning operation, which is performed to prevent a reduction in printing quality due to clogging caused by ink, or during an ink filling operation after a replacement of an ink cartridge; further examples include ones used to absorb ink leaked from a flow path of a printing apparatus.

The above description describes preferred embodiments of the present invention. However, the present invention is not limited to the embodiments described above.

### EXAMPLES

Specific examples of the present invention will now be described.

### [1] Production of Ink Absorption Member

### Example 1

First, a crosslinked polyacrylic acid polymer (partial sodium salt crosslinked product), which is a resin (liquid-absorbent resin) having, in a side chain thereof, a carboxyl group as an acid group, was prepared; namely, Sanfresh ST-250* (manufactured by Sanyo Chemical Industries, Ltd.) was prepared.

Next, Sanfresh ST-250* was subjected to particle size adjustment, and thus, a powder having an average particle diameter of 350 μm was obtained as a liquid-absorbent resin.

Waste paper containing a fiber, which was cellulose, and a binder, which was a polyester, was fiberized to obtain a fiberized material (in Example 5, no binder was present). Subsequently, by using a spray, water was sprayed onto 200 parts by weight of the fiberized material as a whole, which was then mixed with 100 parts by weight of the liquid-absorbent resin (see FIG. 3). Thereafter, the mixture was subjected to a drying process at 50° C. for 24 hours to obtain an ink absorption member.

Note that the content of the liquid-absorbent resin was 6 wt. % relative to the weight of the fiber, the content of the fiber in the ink absorption member was 90 wt. %, the content of the binder in the ink absorption member was 3 wt. %, the average length of the fiber was 1 mm, the average width thereof was 50 μm, and the aspect ratio (average length/average diameter) was 20.

In the ink absorption member obtained in this manner, the liquid-absorbent resin was supported on a surface of the fiber (shredded waste paper).

### Examples 2 to 6

Ink absorption members were produced as in Example 1 except that the conditions for the liquid-absorbent resin, the fiber, and the binder were changed as indicated in Table 1.

### Comparative Examples 1 and 2

Ink absorption members were produced as in Example 1 except that the conditions for the liquid-absorbent resin and the fiber were changed as indicated in Table 1.

### [2] Evaluation 2-1. Evaluation of Diffusibility

First, a plurality of glass containers having internal dimensions of 5 cm×10 cm×10 cm (length, width, and height) were prepared. 0.24 g of the ink absorption members produced in Examples and Comparative Examples were placed in the respective different containers.

Next, 12 g of a commercially available ink jet ink (ICBK-61, manufactured by Seiko Epson Corporation) was poured onto a middle portion in the container storing the ink absorption member. A diffusion rate and a diffusion region (a region in which the ink penetrated) were visually examined. Note that the examination of the diffusion region was performed 10 minutes thickness after the ink had been poured.

A: The diffusion rate was high, and the diffusion region was the entirety of the ink absorption member.

B: The diffusion rate was high, and the diffusion region was substantially the entirety of the ink absorption member.

C: The diffusion rate was rather high, and the diffusion region was the entirety of the ink absorption member.

D: The diffusion rate was rather high, and the diffusion region was substantially the entirety of the ink absorption member.

E: The diffusion rate was low, and there were a considerable number of portions other than the diffusion region (non-diffusion regions).

### 2-2. Evaluation of Leakage Prevention Effect

First, a plurality of glass containers having internal dimensions of 5 cm×10 cm×10 cm (length, width, and height) were prepared. 1.0 g of the ink absorption members produced in Examples and Comparative Examples were placed in the respective different containers.

Next, 100 g of a commercially available ink jet ink (ICBK-61, manufactured by Seiko Epson Corporation) was poured into the container storing the ink absorption member, which was then allowed to stand for 24 hours.

Subsequently, the container was inverted by 90° in a manner such that a vertical surface of the container was brought into contact with a surface of a desk, and the container was left as it was for 10 minutes. When 10 minutes had elapsed, the state of the inside of the container was examined and evaluated according to the following criteria.

A: No shifts of the ink absorption member and the ink were observed.

B: A slight shift of the ink absorption member in the container was observed while no exudation of the ink was observed.

C: A slight exudation of the ink was observed while there was no leakage of the ink absorption member and the ink from the container.

D: Some exudation of the ink was observed while there was no leakage of the ink absorption member and the ink from the container.

E: From the container, at least one of the ink absorption member and the ink leaked from the container.

The results are summarized in Table 1.

TABLE 1

| | Liquid-absorbent resin | | Cellulose fiber | | | | | Evaluations | |
|---|---|---|---|---|---|---|---|---|---|
| | Average particle | | Average | Average | | | Binder | | Leakage |
| | diameter | Content | length | width | Aspect | Content | Presence | | prevention |
| | [μm] | [wt. %] | [mm] | [μm] | ratio | [wt. %] | or absence | Diffusibility | effect |
| Example 1 | 350 | 6 | 1 | 50 | 20 | 90 | Present | B | C |
| Example 2 | 350 | 20 | 1 | 50 | 20 | 80 | Present | A | B |
| Example 3 | 350 | 40 | 1 | 50 | 20 | 60 | Present | A | A |
| Example 4 | 350 | 55 | 1 | 50 | 20 | 50 | Present | A | A |
| Example 5 | 350 | 55 | 1 | 50 | 20 | 50 | Absent | B | B |
| Example 6 | 350 | 70 | 1 | 50 | 20 | 45 | Present | B | A |
| Comparative | 350 | 5 | 1 | 50 | 20 | 99 | Present | D | E |
| example 1 | | | | | | | | | |
| Comparative | 350 | 91 | 1 | 50 | 20 | 45 | Present | E | — |
| example 2 | | | | | | | | | |

As is apparent from Table 1, an excellent leakage prevention effect was produced in each of the examples of the present invention. In contrast, in Comparative Examples 1 and 2, the results were unsatisfactory. Note that in Comparative Example 2, the ink absorption member that had absorbed ink expanded out, and, therefore, the evaluation of the leakage prevention effect could not be performed.

### REFERENCE SIGNS LIST

1 . . . Ink absorption member 2 . . . Fiberized material 20 . . . Fibers 3 . . . Liquid-absorbent resin 4 . . . Binder 10 . . . Container 100 . . . Ink absorber 200 . . . Mixing apparatus 300 . . . Mixing tube 400 . . . Diameter-reduced portion

1. An ink absorption member to be used to absorb ink, the ink absorption member comprising:
paper including fibers, the fibers being coarsely shredded fibers; and
a liquid-absorbent resin supported on the fibers of the paper, wherein
a content of the liquid-absorbent resin is greater than 5 wt. % and 90 wt. % or less relative to a weight of the paper, the paper including the coarsely shredded fibers.

2. The ink absorption member according to claim 1, wherein the paper is previously used waste paper.

3. An ink absorption member to be used to absorb ink, the ink absorption member comprising:
a fiberized material including a cellulose fiber; and
a liquid-absorbent resin, wherein
a content of the liquid-absorbent resin is greater than 5 wt. % and 90 wt. % or less relative to a weight of the fiber, and
a bulk density of the ink absorption member is 0.01 g/cm3 or greater and 0.5 g/cm3 or less.

4. The ink absorption member according to claim 3, wherein an average length of the fiber is 0.1 mm or greater and 7 mm or less.

5. The ink absorption member according to claim 3, wherein an average diameter of the fiber is 0.5 μm or greater and 200 μm or less.

6. The ink absorption member according to claim 3, wherein the liquid-absorbent resin is supported on the fiber.

7. The ink absorption member according to claim 3, wherein a raw material for the fiber is previously used waste paper.

8. The ink absorption member according to claim 3, wherein the liquid-absorbent resin is in a form of particles.

9. The ink absorption member according to claim 1, further comprising a binder.

10. An ink absorber comprising:
the ink absorption member according to claim 1; and
a container storing the ink absorption member.

11. The ink absorption member according to claim 3, further comprising a binder.

12. An ink absorber comprising:
the ink absorption member according to claim 3; and
a container storing the ink absorption member.
